(19) United States
(12) Patent Application Publication
(10) Pub. No.: US 2014/0362095 A1
(43) Pub. Date: Dec. 11, 2014

(54) IMAGE CACHE MEMORY AND SEMICONDUCTOR INTEGRATED CIRCUIT

(71) Applicant: FUJITSU LIMITED, Kawasaki-shi (JP)

(72) Inventor: Noboru YONEOKA, Kawasaki (JP)

(73) Assignee: FUJITSU LIMITED, Kawasaki-shi (JP)

(21) Appl. No.: 14/259,417

(22) Filed: Apr. 23, 2014

(30) Foreign Application Priority Data
Jun. 5, 2013 (JP) 2013-118732

(51) Int. Cl. G06T 1/60

(52) U.S. Cl. CPC G06T 1/60
USPC 345/531; 345/545

(57) ABSTRACT

An image cache memory performs caching of image data, the image cache memory includes a cache buffer, a cache tag unit, a comparator, and a controller. The cache buffer stores cache data for each rectangular block including a plurality of pixels arranged in rectangle, and the cache tag unit stores tags each corresponding to a rectangular-block group including a plurality of rectangular blocks. The comparator makes comparison by using the tags stored in the cache tag unit, and the controller performs the caching by controlling the cache buffer, the cache tag unit, and the comparator.

### CROSS-REFERENCE TO RELATED APPLICATION

This application is based upon and claims the benefit of priority of the prior Japanese Patent Application No. 2013-118732, filed on Jun. 5, 2013, the entire contents of which are incorporated herein by reference.

### FIELD

The embodiments discussed herein are related to an image cash memory and a semiconductor integrated circuit.

### BACKGROUND

In recent years, the speed of image processing has been enhanced by providing an image cache memory between a processor, such as a central processing unit (CPU) or a video encoder, and an external memory, for example.

In such an image cache memory, each single image (a picture or a frame) is divided into multiple rectangular blocks, and data input and output as well as data storing and management in a cache buffer included in the image cache memory are performed on a block-by-block basis, for example.

Specifically, data storing and management in the cache buffer are performed block by block, and the operations are controlled by a cache tag unit for storing tags corresponding to the respective rectangular blocks and a comparison unit for making comparisons using the tags.

In the above-described image cache memory, the number of tags stored in the cache tag unit increases as the capacity of the cache buffer becomes larger, for example.

Such an increase in the number of tags causes the time for comparison by the comparison unit and the complexity of the hardware configuration of the comparison unit to increase. In other words, the increasing of the number of tags results in increases in time for the cache processing and hardware cost.

By the way, in the past, various techniques for controlling caching by providing an image cache memory between a processor and an external memory and dividing each image into multiple rectangular blocks, have been proposed.

In this regard, various receiving devices with a characteristic improved by processing an input signal of a detector are being proposed.

Patent Document 1: Japanese Laid-open Patent Publication No. H10-261076

Patent Document 2: Japanese Laid-open Utility Model Publication No. H06-059975

### SUMMARY

According to an aspect of the embodiments, there is provided an image cache memory performs caching of image data, the image cache memory includes a cache buffer, a cache tag unit, a comparator (comparison unit), and a controller (control unit).

The cache buffer stores cache data for each rectangular block including a plurality of pixels arranged in rectangle, and the cache tag unit stores tags each corresponding to a rectangular-block group including a plurality of rectangular blocks.

The comparator makes comparison by using the tags stored in the cache tag unit, and the controller performs the caching by controlling the cache buffer, the cache tag unit, and the comparator.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram for illustrating the entire configuration of a semiconductor integrated circuit;

FIG. 2 is a diagram for illustrating the relationship between a picture and rectangular blocks;

FIG. 3 is a diagram for illustrating a cache tag unit and a comparison unit in an example of an image cache memory;

FIG. 4 is a diagram for illustrating a rectangular-block group in an image cache memory of an embodiment;

FIG. 5 is a diagram for illustrating a cache buffer address corresponding to tags of the rectangular-block group illustrated in FIG. 4;

FIG. 6 is a diagram for illustrating an example of a cache tag unit and a comparison unit in the image cache memory of the embodiment;

FIG. 7 is a diagram for illustrating accesses at the time of a cache miss in the image cache memory of the embodiment;

FIG. 8 is a diagram for illustrating an example of tag merging in the image cache memory of the embodiment (Part 1);

FIG. 9 is a diagram for illustrating the example of tag merging in the image cache memory of the embodiment (Part 2);

FIG. 10 is a diagram for illustrating a modified example of the tag merging in the image cache memory of the embodiment (Part 1);

FIG. 11 is a diagram for illustrating the modified example of the tag merging in the image cache memory of the embodiment (Part 2); and

FIG. 12 is a diagram for illustrating a different example of the cache tag unit and the comparison unit in the image cache memory of the embodiment.

### DESCRIPTION OF EMBODIMENTS

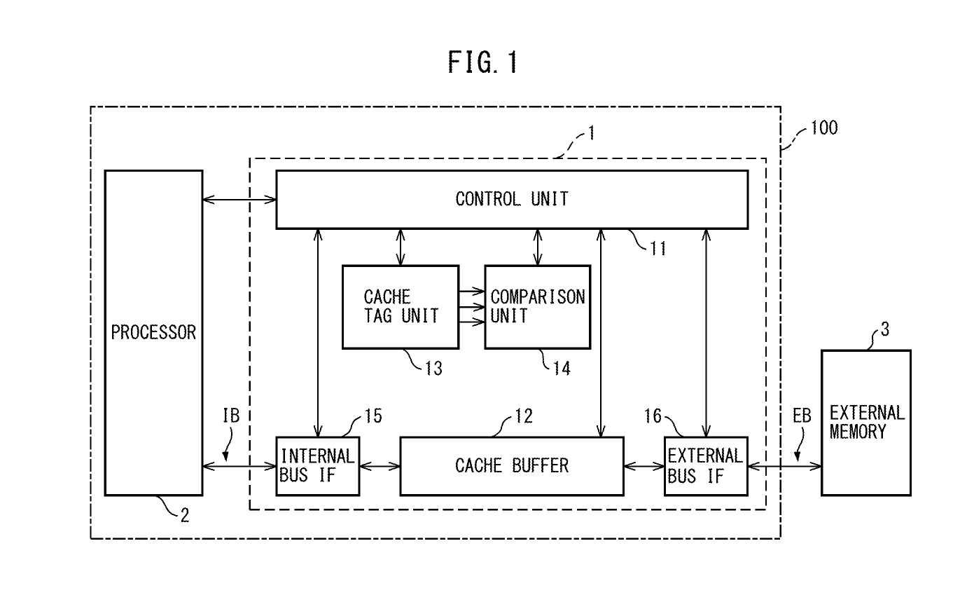

First, prior to detailed description of an embodiment of an image cache memory and a semiconductor integrated circuit, description will be given of an example of a semiconductor integrated circuit including an image cache memory and problems of such an image cache memory, by referring to FIG. 1 to FIG. 3.

FIG. 1 is a block diagram for illustrating the entire configuration of a semiconductor integrated circuit. As illustrated in FIG. 1, a semiconductor integrated circuit 100 includes an image cache memory 1, and a processor (image processor) 2 such as a CPU or a video encoder. The image cache memory 1 is provided between the processor 2 and an external memory 3. The external memory 3 may be a synchronous dynamic random access memory (SDRAM), for example.

The image cache memory 1 includes: a control unit (controller) 11 for controlling the entire image cache memory 1; a cache buffer 12 for storing cache data; and a cache tag unit 13 for managing data (image data) in the cache buffer 12.

Moreover, the image cache memory 1 further includes: a comparison unit (comparator) 14 for determining whether or not desired data is stored in the cache buffer 12, on the basis of the tags stored in the cache tag unit 13; an internal bus interface (IF) 15; and an external bus IF 16.

The internal bus IF 15 is connected to the processor 2 via an internal bus IB, and is used to exchange data between the processor 2 and the cache buffer 12. The external bus IF 16 is connected to the external memory 3 via an external bus EB, and is used to exchange data between the external memory 3 and the cache buffer 12.

The control unit 11 controls the cache buffer 12, the cache tag unit 13, the comparison unit 14, the internal bus IF 15, and the external bus IF 16, according to instructions from the processor 2, for example, to thereby control caching in the image cache memory 1.

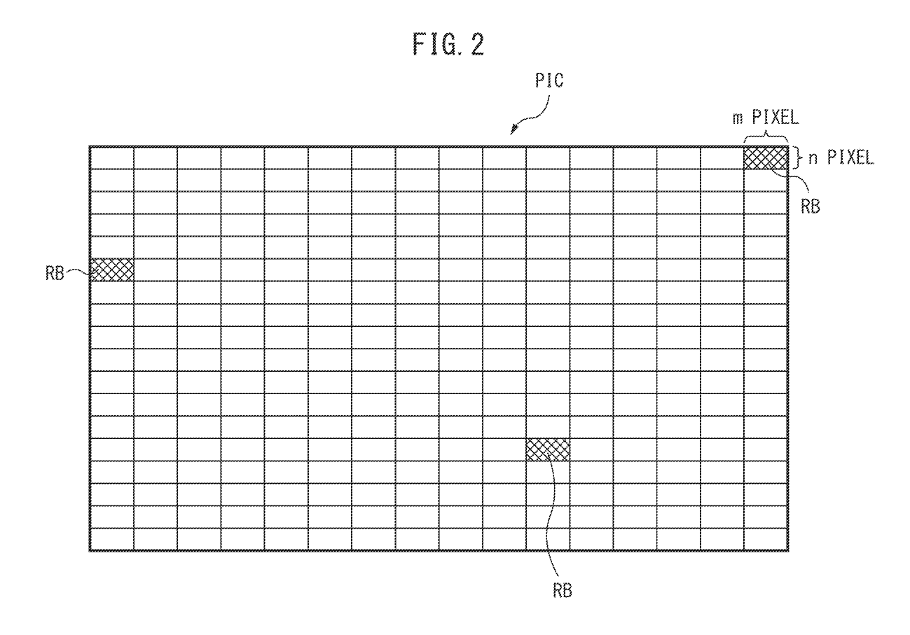

FIG. 2 is a diagram for illustrating the relationship between a picture and rectangular blocks. As illustrated in FIG. 2, when input/output data is an image, a picture (image or frame) PIC is usually divided into multiple rectangular blocks RB.

FIG. 2 represents a case in which the single picture PIC is divided into 18 vertically and 16 horizontally, i.e. 18×16=288 rectangular blocks RB in total. In addition, each rectangular block RB consists of m pixels horizontally and n pixels vertically.

Accordingly, the data management for the single picture PIC is performed block by block, each rectangular block RB consisting of m×n pixels, and data input and output as well as data storing and management in the cache buffer 12 are performed by using each rectangular block RB as a unit.

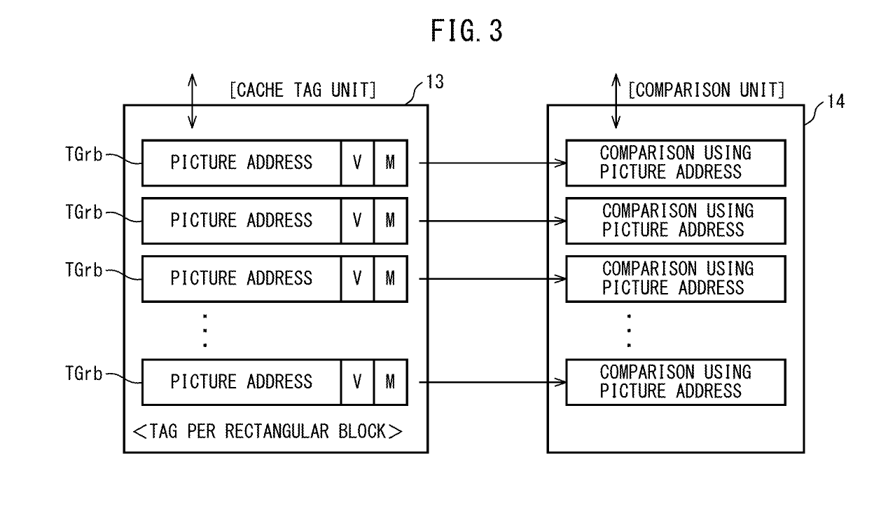

FIG. 3 is a diagram for illustrating a cache tag unit and a comparison unit in an example of the image cache memory. As illustrated in FIG. 3, the cache tag unit 13 stores multiple tags TGrb.

The tags TGrb stored in the cache tag unit 13 correspond to the respective rectangular blocks RB stored in the cache buffer 12. Accordingly, the number of tags TGrb in the cache tag unit 13 is equal to the maximum number of the rectangular blocks RB stored in the cache buffer 12.

Each tag TGrb includes: a picture address (x,y) indicating the position of a corresponding rectangular block RB in the picture PIC; a V flag indicating whether the tag is valid or invalid; and an M flag indicating whether or not corresponding data in the cache buffer 12 has been changed by the processor 2.

For example, when the rectangular block RB corresponding to a certain tag TGrb is stored in the cache buffer 12, the V flag of the tag is set at “1” (valid); when the rectangular block RB is not stored in the cache buffer 12, the V flag is set at “0” (invalid).

In addition, for example, when the data of the rectangular block RB corresponding to the certain tag TGrb has been rewritten by the processor 2, i.e., when the data of the rectangular block RB stored in the cache buffer 12 is different from the corresponding data in the external memory 3, the M flag of the tag is set at “1”.

By contrast, when the data of the rectangular block RB corresponding to the certain tag TGrb has been held by the cache buffer 12 without being rewritten, i.e., when the data is identical to the corresponding data in the external memory 3, the M flag of the tag is set at “0”.

By referring to FIG. 1 to FIG. 3, an example of operations of the image cache memory will be described. First, during read access to the image cache memory 1 by the processor 2, the control unit 11 checks whether or not a rectangular block RB having the picture address (x,y) corresponding to the read access is stored in the cache buffer 12.

Specifically, the control unit 11 causes the comparison unit 14 to scan the multiple tags TGrb in the cache tag unit 13. Then, when a tag having the V flag set valid (“1”) and the picture address matching with that of the read access is found in the cache tag unit 13, the comparison unit 14 determines that the access results in a cache hit. Then, the control unit 11 transfers the data of the rectangular block RB having the tag corresponding to the cache hit, from the cache buffer 12 to the processor 2.

On the other hand, when no tag having the V flag set valid and the picture address matching with that of the read access is found in the cache tag unit 13, the comparison unit 14 determines that the read access results in a cache miss. Then, the control unit 11 reads the data of the rectangular block RB having the tag corresponding to the cache miss, from the external memory 3 into the cache buffer 12. Subsequently, the control unit 11 updates the picture address (x,y) of the tag corresponding to the read rectangular block RB, and sets the V flag to be valid (“1”) and the M flag to be invalid (“0”).

Next, during write access to the image cache memory 1 by the processor 2, the control unit 11 checks whether or not a rectangular block RB having the picture address (x,y) corresponding to the write access is stored in the cache buffer 12. Specifically, the control unit 11 causes the comparison unit 14 to scan the multiple tags TGrb stored in the cache tag unit 13.

When the tag having the V flag set valid and the picture address matching with that of the write access is found in the cache tag unit 13, the control unit 11 rewrites the data of the corresponding rectangular block RB in the cache buffer 12 with the data from the processor 2. In addition, the cache tag unit 13 sets the M flag of the tag corresponding to the rectangular block RB having the data rewritten, to be valid (“1”).

On the other hand, when no tag having the V flag set valid and the picture address matching with that of the write access is found in the cache tag unit 13, the control unit 11 stores the data from the processor 2 in a new area of the cache buffer 12. Then, the cache tag unit 13 updates the picture address (x,y) in a corresponding new tag, and sets the V flag to be valid (“1”) and the M flag to be valid (“1”).

When a read access results in a cache miss, or when sufficient space is not available in the cache buffer 12 during write access, in the above, space is made available by purging data from the cache buffer 12.

Specifically, the control unit 11 causes the comparison unit 14 to scan the tags TGrb in the cache tag unit 13, and purges the tags TGrb each having the V flag set valid and the corresponding rectangular blocks RB (data areas) in the cache buffer 12.

Note that the purging order of data from the cache buffer 12 may be determined by using the method of assigning a higher priority to data that has been accessed least recently on the basis of a cache algorithm, Least Recently Used (LRU), for example. Alternatively, a different cache algorithm used in an image processor may be used, for example.

When the M flag of a tag to be purged is set valid (“1”), this means that the corresponding data has been rewritten by the processor 2, and hence the data of the rectangular block RB corresponding to the tag in the cache buffer 12 needs to be written in (written back to) the external memory 3.

In the above-described image cache memory 1, the number of tags stored in the cache tag unit 13 increases according to the capacity of the cache buffer 12, for example. Moreover, the increasing in the number of tags results in increases in time for the comparison by the comparison unit 14 and hardware cost of the comparison unit 14.

In general, the size of each rectangular block RB is determined in view of the minimum granularity in accessing the external memory 3 and the width of the external bus. Specifically, assume that the size of each rectangular block RB is 256 bits, for example. In this case, when a single pixel consists of 8 bits, the rectangular block RB is the size of 8 pixels horizontally×4 pixels vertically, or 16 pixels horizontally×2 pixels vertically.

However, when accessing the image cache memory 1, the processor 2 often uses a rectangle that is larger than the rectangular block RB, as a unit for a series of operations.

For example, in a video encoder or the like, a rectangle in the range between 16 pixels×16 pixels and 64 pixels×64 pixels is generally used as a unit for operations. Accordingly, each rectangle used for accessing the processor 2 is one close to the above size, which is larger than the size of each rectangular block RB.

In such a case, performing data management using a rectangle larger than the rectangular block RB as a management unit, can reduce the number of tags to be needed compared to that when the tag TGrb is assigned for each rectangular block RB, in the image cache memory 1.

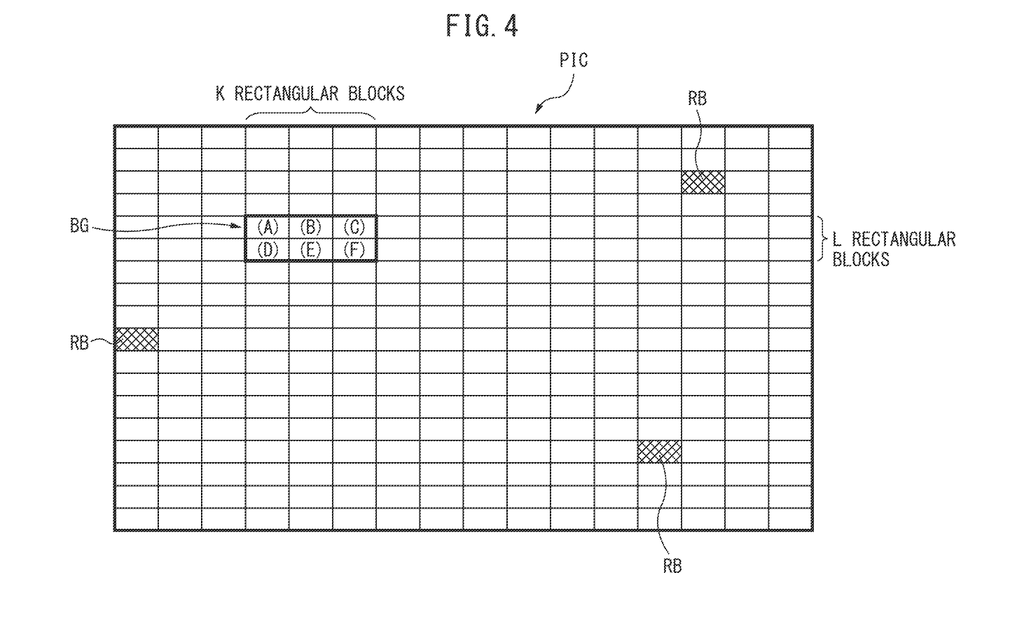

In the following, an image cache memory of an embodiment will be described by referring to the accompanying drawings. FIG. 4 is a diagram for illustrating a rectangular-block group in the image cache memory of this embodiment.

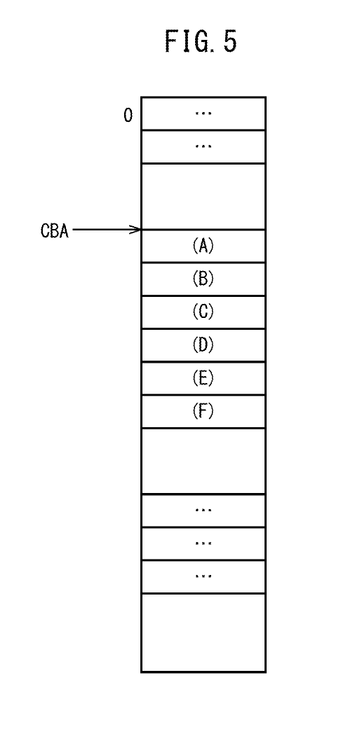

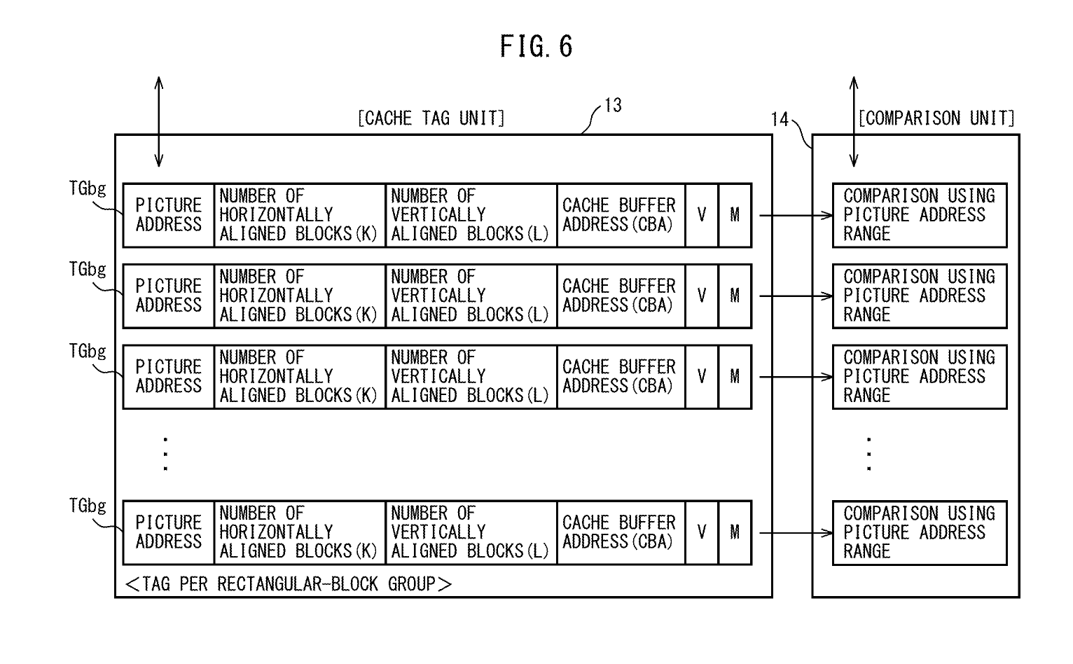

Moreover, FIG. 5 is a diagram for illustrating a cache buffer address in a tag for the rectangular-block group illustrated in FIG. 4. FIG. 6 is a diagram for illustrating an example of a cache tag unit and a comparison unit in the image cache memory of this embodiment.

Note that the entire configuration of an image cache memory 1 and a semiconductor integrated circuit of this embodiment is the same as that described by referring to FIG. 1. However, a cache tag unit 13 and a comparison unit (comparator) 14 are different from those described above by referring to FIG. 3, as will be described in detail by referring to FIG. 6.

[Tag Configuration]

As illustrated in FIG. 4 and FIG. 6, a single tag TGbg is assigned to a rectangular-block group BG consisting of multiple rectangular blocks RB ((A) to (F)), in the image cache memory 1 of this embodiment.

As illustrated in FIG. 4, the rectangular-block group BG consists of K rectangular blocks horizontally and L rectangular blocks vertically, for example. In other words, the single rectangular-block group BG consists of K×L rectangular blocks RB. Specifically, in the example illustrated in FIG. 4, the numbers of the blocks are set to K=3 and L=2; accordingly, the single rectangular-block group BG consists of six rectangular blocks RB ((A) to (F)).

As illustrated in FIG. 6, each tag TGbg includes a picture address, the number of horizontally aligned blocks (K), the number of vertically aligned blocks (L), a cache buffer address (CBA), a V flag, and an M flag. The picture address is represented by using, as the origin (0,0), the rectangular block (A) positioned upper-left most in the rectangular-block group BG corresponding to the tag TGbg.

As illustrated in FIG. 5, the six rectangular blocks RB (A) to (F) positioned in the rectangular-block group BG illustrated in FIG. 4 are sequentially arranged from an address in the cache buffer 12, and the cache buffer address CBA of each tag TGbg indicates the starting position of the six rectangular blocks RB (A) to (F).

A position (cache buffer address) Adr of each of the rectangular blocks RB ((A) to (F)) in the rectangular-block group BG is obtained as follows.

For example, with respect to the rectangular block (A) as the origin (0,0), the rectangular block (E) is apart by “1” horizontally (rightward) and apart by “1” vertically (downward). Hence, the relative block coordinates of the rectangular block (E) in the rectangular-block group BG is (Bx,By)=(1,1).

In addition, for example, with respect to the rectangular block (A) as the origin (0,0), the rectangular block (F) is apart by “2” horizontally (rightward) and apart by “1” vertically (downward). Hence, the relative block coordinates of the rectangular block (F) in the rectangular-block group BG is (Bx,By)=(2,1).

A cache buffer address Adr(E) of the rectangular block (E) and a cache buffer address Adr(F) of the rectangular block (F) are obtained as follows.

$$\begin{matrix}\begin{matrix}Adr ( E ) = CBA + K \times By + Bx \\ = CBA + K \times 1 + 1\end{matrix} & \\ Adr ( F ) = CBA + K \times 1 + 2 & \end{matrix}$$

[Operations of Comparison Unit]

Next, operations of the comparison unit (comparator) 14 will be described. At the time of checking whether or not a desired rectangular block RB is stored in the cache buffer 12, the comparison unit 14 scans the tags TGbg stored in the cache tag unit 13.

In other words, for checking whether or not the desired rectangular block RB is stored in the cache buffer 12, the comparison unit 14 compares the picture address range indicated by each of the tags TGbg in the cache tag unit 13 and the picture address (Sx,Sy) of the desired rectangular block RB. Specifically, the comparison unit 14 illustrated in FIG. 6 carries out the following process for each of the tags TGbg in the cache tag unit 13.

The comparison unit 14 determines, with respect to the tag TGbg, that the access results in a hit when

the V flag of the tag TGbg is valid,

Picture address(x)≦Sx≦Picture address(x)+(K−1) and

Picture address(y)≦Sy≦Picture address(y)+(L−1),

while determining, with respect to the tag TGbg, that the access results in a miss when the above conditions are not satisfied.

Assume that the target block is denoted by Q and the tag of the block Q is denoted by H, at the time of a cache hit. In this case, a cache buffer address Adr(Q) of the target block Q is calculated as follows.

Bx=Q Picture address(x)−H Picture address (x)

By=Q Picture address(y)−H Picture address (y)

Adr(Q)=H Cache buffer address+K×By+Bx

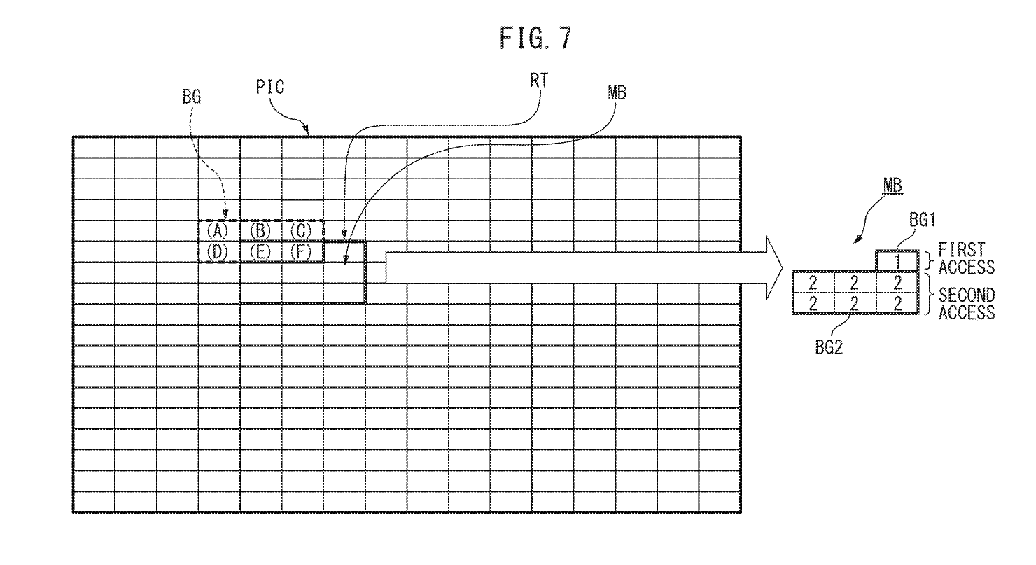

FIG. 7 is a diagram for illustrating accesses at the time of a cache miss in the image cache memory of this embodiment. In FIG. 7, reference letters RT denote blocks (data areas) for which an access request has been issued by the processor 2, and reference letters MB denote the blocks each corresponding to a cache miss.

Next, operations at the time of a read access and a write access will be described. In the operations, assume that the processor 2 makes a read access or a write access to the image cache memory 1 for a group of multiple rectangular blocks (rectangular-block group BG) in rectangle.

[Read Access Operations]

When the processor 2 makes a read access to the image cache memory 1, the control unit (controller) 11 checks, for each of the multiple rectangular blocks RB corresponding to the read access, whether or not the rectangular block RB is stored in the cache buffer 12.

Specifically, the control unit 11 causes the comparison unit 14 to scan the tags TGbg in the cache tag unit 13 and then perform the above-described comparison operations, thereafter transferring the blocks each corresponding to a cache hit (the rectangular blocks (E) and (F) in FIG. 7, for example) from the cache buffer 12 to the processor 2.

The blocks MB (a hatching part in FIG. 7) each corresponding to a cache miss are divided into rectangular shapes as extracted and represented on the right side in FIG. 7, and the respective rectangular shapes are read from the external memory 3 into the cache buffer 12 as a rectangular-block group BG1 and a rectangular-block group BG2.

In other words, the blocks MB each corresponding to a cache miss are divided into the rectangular-block group BG1 consisting of a single rectangular block RB and the rectangular-block group BG2 consisting of six rectangular blocks RB.

In this case, for example, the rectangular-block group BG1 is read into the cache buffer 12 in the first access to the external memory 3, while the rectangular-block group BG2 is read into the cache buffer 12 in the second access to the external memory 3.

For each of the rectangular-block groups BG1 and BG2 thus read, a new tag is prepared, and the picture address, the number of horizontally aligned blocks (K), the number of vertically aligned blocks (L), and the cache buffer address (CBA) of the tag are updated. In addition, the V flag of the tag for each of the rectangular-block groups BG1 and BG2 is set valid (“1”), and the M flag of the tag is set invalid (“0”).

[Write Access Operations]

Next, when the processor 2 has made a write access to the image cache memory 1, the control unit 11 checks, for each of multiple rectangular blocks RB corresponding to the write access, whether or not the rectangular block RB is stored in the cache buffer 12.

Specifically, the control unit 11 causes the comparison unit 14 to scan the tags TGbg in the cache tag unit 13 and then perform the above-described comparison operations, thereafter rewriting each of the blocks corresponding to a cache hit (the rectangular blocks (E) and (F) in FIG. 7, for example) with the data (image data) from the processor 2. Then, the M flag of the tag TGbg for the rectangular blocks (E) and (F) each corresponding to a cache hit is set valid (“1”).

The blocks MB each corresponding to a cache miss are divided into rectangular shapes as extracted and represented on the right side in FIG. 7, and the respective rectangular shapes are stored in the cache buffer 12 as the rectangular-block groups BG1 and BG2.

In other words, the blocks MB each corresponding to a cache miss are divided into the rectangular-block group BG1 consisting of a single rectangular block RB and the rectangular-block group BG2 consisting of six rectangular blocks RB.

In this case, for example, the rectangular-block group BG1 is written into the cache buffer 12 in the first access, while the rectangular-block group BG2 is written into the cache buffer 12 in the second access.

For each of the rectangular-block groups BG1 and BG2 stored in the cache buffer 12, a new tag is prepared, and the picture address, the number of horizontally aligned blocks (K), the number of vertically aligned blocks (L), and the cache buffer address (CBA) of the tag are updated. In addition, the V flag of the tag for each of the rectangular-block groups BG1 and BG2 is set valid (“1”), and the M flag of the tag is set valid (“1”).

[Cache Purge Operations]

When a read access results in a cache miss in a read access, or when sufficient space is not available in the cache buffer 12 during write access, in the above, space is made available by purging data from the cache buffer 12.

Specifically, the control unit 11 causes the comparison unit 14 to scan the tags TGbg in the cache tag unit 13, then purging the tags TGbg each having the V flag set valid and the rectangular blocks (data areas) corresponding to the tags TGbg in the cache buffer 12.

Note that the purging order of data in the cache buffer 12 may be determined by using the method of assigning a higher priority to data that was accessed least recently on the basis of a cache algorithm, Least Recently Used (LRU), for example, as described above. Alternatively, a different cache algorithm used in an image processor may be used, for example.

When the M flag of a tag to be purged is set valid (“1”), this means that the corresponding data has been rewritten by the processor 2, and hence the data of the rectangular block RB corresponding to the tag in the cache buffer 12 needs to be written in (written back to) the external memory 3.

In this way, with the image cache memory of this embodiment, the number of the tags stored in the cache tag unit 13 can be reduced compared to the case described by referring to FIG. 1 to FIG. 3, for example. Consequently, the time for the comparison by the comparison unit 14 and the hardware cost of the comparison unit 14 can be reduced, for example.

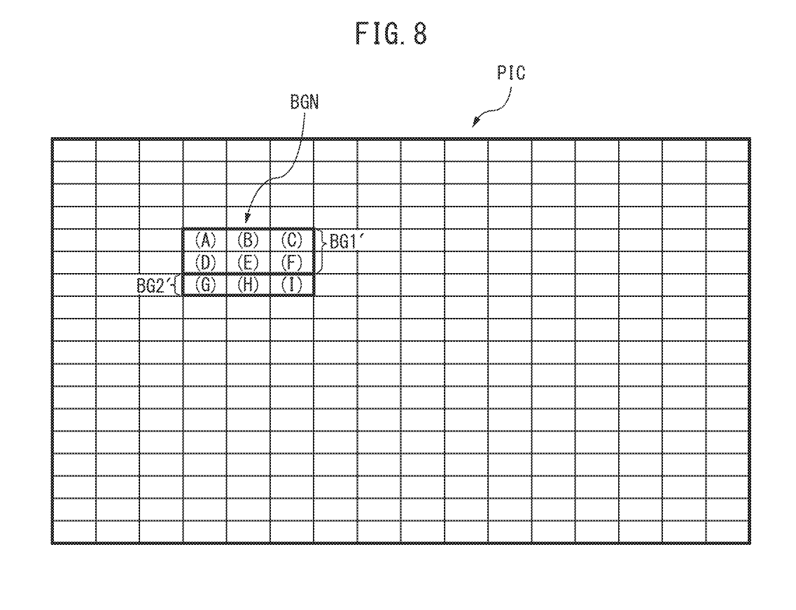

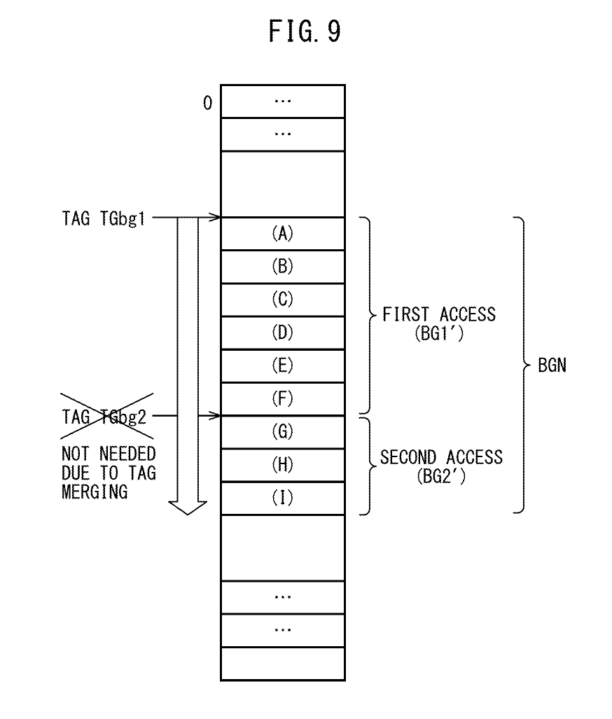

FIG. 8 and FIG. 9 are diagrams for illustrating an example of tag merging in the image cache memory of this embodiment.

[Tag Merging]

When the access size by the processor 2 is fixed and the processor 2 repeats an access to the region adjacent to that of the previous access, for example, the multiple access regions of the accesses as a whole form a rectangle.

As illustrated in FIG. 8, for example, when the processor 2 accesses regions (A)(B)(C) and (D)(E)(F), i.e., three horizontally adjacent regions×two vertically adjacent regions, in the first access, and then accesses a region (G)(H)(I), i.e., three horizontally adjacent regions, in the second access, the regions as a whole form a rectangle.

In other words, a rectangular-block group BG1′ ((A)(B)(C) and (D)(E)(F)) of the first access and a rectangular-block group BG2′ ((G)(H)(I)) of the second access can be combined into a single rectangular-block group BGN.

Then, a single tag is assigned to the new single rectangular-block group BGN obtained by combining the regions (A)(B)(C), (D)(E)(F), and (G)(H)(I), i.e., three horizontally adjacent blocks×three vertically adjacent blocks.

As illustrated in FIG. 9, assigning only a single tag TGbg1, instead of two tags TGbg1 and TGbg2, to the new rectangular-block group BGN, can further reduce the number of tags.

Specifically, the use of a new tag can be prevented in such a manner that the control unit 11 performs <Process 1> and <Process 2> to be described below.

<Process 1>

For storing a new rectangular-block group BGN (BG1′ and BG2′) in the cache buffer 12 at the time of a cache miss, the following tag is searched for in which:

the V flag is set valid (“1”),

the number of horizontally aligned blocks (K) is equal to the number of horizontally aligned blocks of the new rectangular-block group BGN (i.e., the number of horizontally aligned blocks of the rectangular-block group BG1′ in the first access is the same as the number of horizontally aligned blocks of the rectangular-block group BG2′ in the second access),

the M flag is invalid (“0”) in a read access, or the M flag is valid (“1”) in a write access, and
the region corresponds to the vertical-direction upper or lower part of the rectangular-block group BGN (i.e., the regions of the rectangular-block group BG1′ of the first access are adjacent to the vertically upper or lower side of the region of the rectangular-block group BG2′ of the second access).

<Process 2>

When no corresponding tag is found in the above <Process 1>, the use of a new tag is difficult to prevent, and hence a new tag is assigned to the rectangular-block group BGN.

By contrast, when a corresponding tag (TGbg1) is found, no new tag is assigned to the rectangular-block group BGN (BG1′ and BG2′). Instead, the tag TGbg1 is rewritten as follows.

The number of vertically aligned blocks (L) of the tag TGbg1 is rewritten with the number of vertically aligned blocks of the new rectangular-block group BGN, and,

when the regions corresponding to the tag TGbg1 are positioned in a lower part of the rectangular-block group BGN, the picture address of the tag TGbg1 is rewritten with the picture address of the rectangular-block group BGN. In this way, the use of a new tag can be prevented.

By merging a tag for a read region and a tag for a write region, for example, the read region and the write region are managed by a single tag having the M flag set valid. This causes the read region to be written into the external memory 3 together with the write region at the time of cache purge.

To suppress increases in data amount and time for an access to the external memory 3, tag merging is preferably performed on the tags for read regions (i.e., regions having the M flags set invalid) or the tags for write regions (i.e., regions having the M flags set valid), independently.

As described by referring to FIG. 8 and FIG. 9, the address scanning performed on the rectangular blocks of a rectangular-block group in the cache buffer 12 is horizontal scanning.

Accordingly, in consideration of enabling the block addresses in the cache buffer 12 to be in sequence, the above-described tag merging process is difficult to perform on the rectangular-block groups BG that are only vertically adjacent to each other.

The processor 2 of some types for accessing the image cache memory 1 accesses the horizontally adjacent regions instead of vertically adjacent regions.

In this case, the vertical scanning is preferably employed for address scanning of the rectangular blocks in the rectangular-block group in the cache buffer 12.

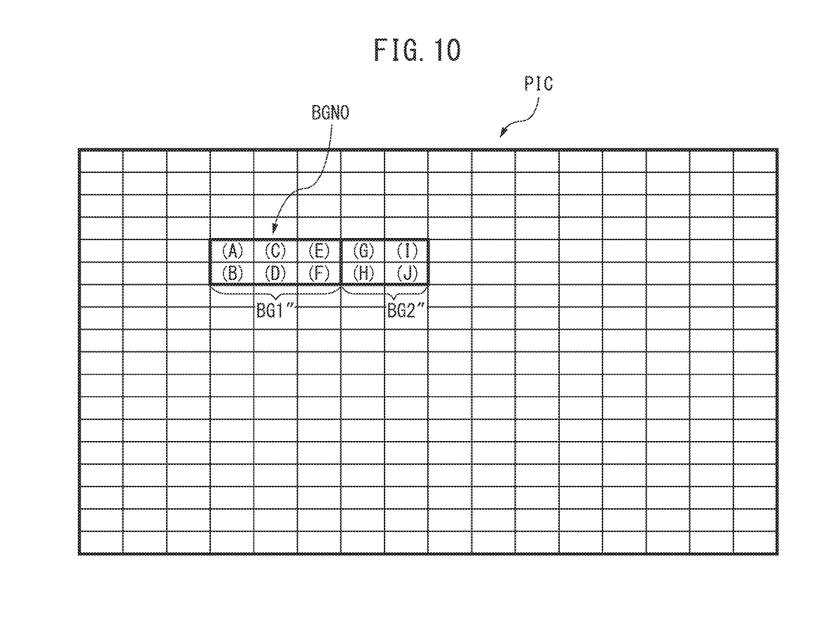

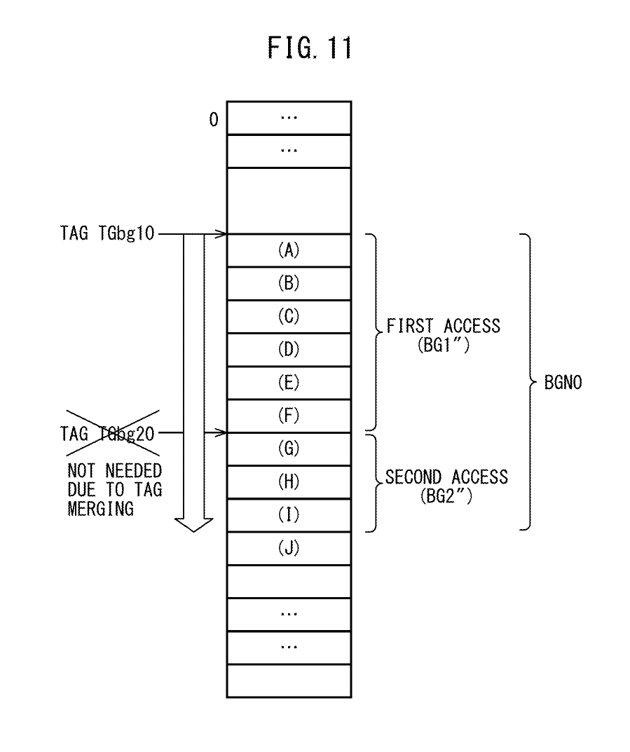

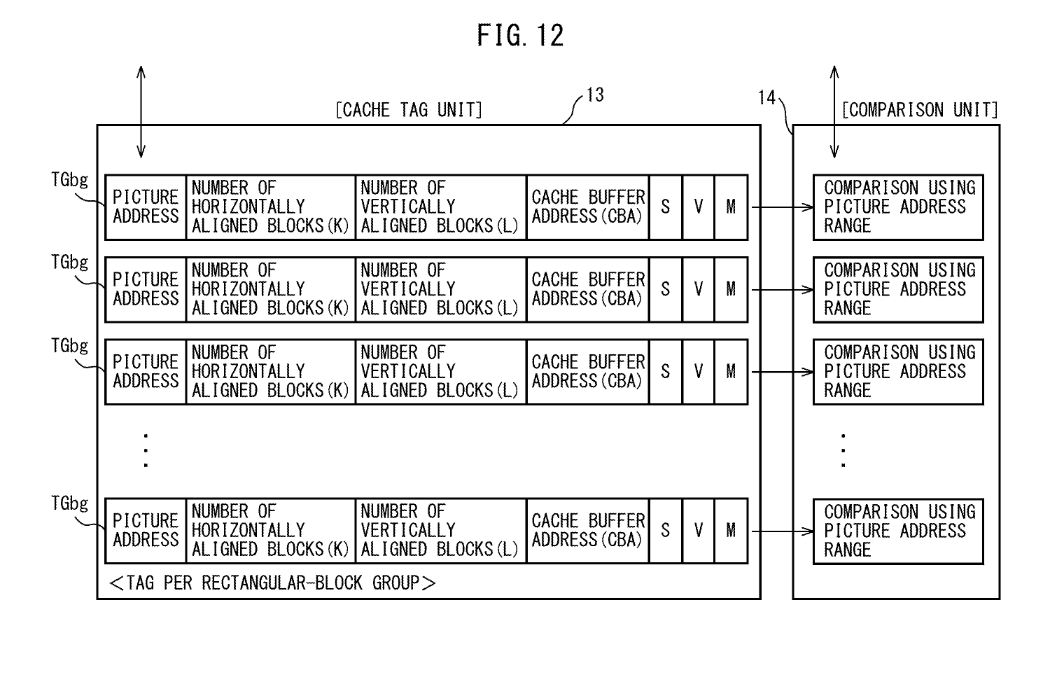

FIG. 10 and FIG. 11 are diagrams for illustrating a modified example of the tag merging in the image cache memory of this embodiment, and FIG. 12 is a diagram for illustrating an example of a tag for a rectangular-block group represented in FIG. 10.

As is clear from a comparison between FIG. 12 and FIG. 6 described above, the tag for a rectangular-block group BGN0 in the modified example of the tag merging further includes an S flag indicating whether the address scanning direction is set to be horizontal or vertical, in addition to the above-described tag for the rectangular-block group BGN.

For example, the S flag is set at “0” when the address scanning direction for the rectangular blocks in a rectangular-block group in the cache buffer 12 is set to be horizontal, while being set at “1” when the address scanning direction is set to be vertical.

In other words, S=0 indicates that the address scanning for the corresponding blocks in the cache buffer 12 is to be performed in the horizontal direction; by contrast, S=1 indicates that the address scanning is to be performed in the vertical direction.

The image cache memory 1 switches between horizontal scanning (i.e. address scanning in the horizontal direction) and vertical scanning (i.e. address scanning in the vertical direction) depending on the direction externally set or according to an identifying signal from the processor 2, for example.

In the tag merging, the tags having the S flag set at S=0 can be merged together when being vertically adjacent to each other, while the tags having the S flag set at S=1 can be merged together when being horizontally adjacent to each other.

In the case of S=0, the tag merging process is the same as that described by referring to FIG. 8 and FIG. 9, for example, and hence description of this case is omitted. In the following, description will be given of the case of S=1, i.e., a case of vertical scanning, by referring to FIG. 10 and FIG. 11.

FIG. 10 illustrates a case in which S=1, and the first access is made for the regions (A)(B), (C)(D), and (E)(F), i.e., two vertically adjacent blocks×three horizontally adjacent blocks while the second access is made for the regions (G)(H) and (I)(J), i.e., two vertically adjacent blocks×two horizontally adjacent blocks.

In this case, a rectangular-block group BG1″ ((A)(B), (C)(D), and (E)(F)) of the first access and a rectangular-block group BG2″ ((G)(H) and (I)(J)) of the second access are combined as the single rectangular-block group BGN0.

Consequently, the new rectangular-block group BGN0 is obtained by combining the regions (A)(B), (C)(D), (E)(F), (G)(H), and (I)(J) of the first access and the second access, i.e., two vertically adjacent blocks×five horizontally adjacent blocks, and a single tag is assigned to the new rectangular-block group BGN0.

As illustrated in FIG. 11, tag merging is performed so that only a single tag TGbg10, instead of two tags TGbg10 and TGbg20, would be assigned to the new rectangular-block group BGN0. In this way, the number of tags can be reduced.

The calculation of the cache buffer address (CBA) of each block in the tag is different in the case of S=1 from that in the case of S=0. Specifically, when a target block is denoted by Q and the corresponding tag is denoted by R, the cache buffer address Adr(Q) of the target block Q is calculated as follows.

Bx=Q Picture address x−R Picture address x

By=Q Picture address y−R Picture address y

Adr(Q)=R cache buffer address+L×Bx+By

Hence, in the modified example described by referring to FIG. 10 to FIG. 12, tag merging can be performed in both horizontal scanning and vertical scanning.

As has been described, using the image cache memory of this embodiment can reduce the number of tags corresponding to the data pieces stored in the cache buffer. Moreover, the tag merging enables a smaller number of tags to manage a cache buffer with a large capacity.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An image cache memory for performing caching of image data, the image cache memory comprising:
a cache buffer configured to store cache data for each rectangular block including a plurality of pixels arranged in rectangle;
a cache tag unit configured to store tags each corresponding to a rectangular-block group including a plurality of rectangular blocks;
a comparator configured to make comparison by using the tags stored in the cache tag unit; and
a controller configured to perform the caching by controlling the cache buffer, the cache tag unit, and the comparator.

2. The image cache memory according to claim 1, wherein the rectangular-block group includes:
K rectangular blocks aligned horizontally; and
L rectangular blocks aligned vertically, wherein
each of K and L is a positive integer, and
at least one of K and L is larger than or equal to two.

3. The image cache memory according to claim 2, wherein each of the tags includes:
the number of horizontally aligned blocks K, which is number of the horizontally aligned rectangular blocks included in the rectangular-block group;
the number of vertically aligned blocks L, which is number of the vertically aligned rectangular blocks included in the rectangular-block group;
a picture address indicating a position, in a picture, of a corresponding one of the rectangular blocks;
a first flag indicating whether a corresponding tag is valid or invalid; and
a second flag indicating whether or not corresponding data in the cache buffer has been changed.

4. The image cache memory according to claim 3, wherein, during read access, the controller
causes the comparator to scan the tags stored in the cache tag unit,
reads out, from the cache buffer, a block corresponding to a cache hit for data of the read access,
divides, into rectangles, blocks each corresponding to a cache miss for the data of the read access, and then reads each of the rectangles as the rectangular-block group, into the cache buffer, and
prepares a new tag for the rectangular-block group read into the cache buffer, and setting the first flag of the new tag to be valid while setting the second flag of the new tag to be invalid.

5. The image cache memory according to claim 3, wherein, during write access, the controller
causes the comparator to scan the tags stored in the cache tag unit,
rewrites a block corresponding to a cache hit for data of the write access, with data of the write access, while setting the second flag of one of the tags that is for the block corresponding to the cache hit, to be valid,
divides, into rectangles, blocks each corresponding to a cache miss for the data of the write access, and then stores each of the rectangles as the rectangular-block group in the cache buffer, and
prepares a new tag for the rectangular-block group stored in the cache buffer, and setting the first flag of the new tag to be valid while setting the second flag of the new tag to be valid.

6. The image cache memory according to claim 3, wherein
the controller merges one of the tags that corresponds to a first access and one of the tags that corresponds to a second access together when an access size is fixed and the second access is made for a region adjacent to that of the first access, the first access being immediately before the second access.

7. The image cache memory according to claim 3, wherein
each of the tags further includes a third flag indicating whether address scanning is in a first direction or a second direction orthogonal to the first direction.

8. The image cache memory according to claim 7, wherein
the controller merges a tag corresponding to the first access and a tag corresponding to the second access when an access size is fixed, address scanning for the first access and the address scanning for the second access are in the first scanning direction specified by the third flag, and the first access and the second access are made for regions adjacent to each other in the second direction, the first access being immediately before the second access.

9. The image cache memory according to claim 8, wherein, when
a first rectangular-block group of the first access includes K rectangular blocks aligned in the first direction, and
a second rectangular-block group of the second access includes K rectangular blocks aligned in the first direction while a region of the second rectangular-block group is adjacent to a region of the first rectangular-block group in the second direction,
the controller manages the first rectangular-block group and the second rectangular-block group as a new third rectangular-block group, by using a new tag corresponding to the new third rectangular-block group.

10. A semiconductor integrated circuit, comprising an image cache memory for performing caching of image data, and a processor, wherein
the image cache memory comprises:
a cache buffer configured to store cache data for each rectangular block including a plurality of pixels arranged in rectangle;
a cache tag unit configured to store tags each corresponding to a rectangular-block group including a plurality of rectangular blocks;
a comparator configured to make comparison by using the tags stored in the cache tag unit; and
a controller configured to perform the caching by controlling the cache buffer, the cache tag unit, and the comparator, and
the processor causes the controller of the image cache memory to perform caching of image data stored in an external memory.

11. The semiconductor integrated circuit according to claim 10, wherein, during read access by the processor, the controller
causes the comparator to scan the tags stored in the cache tag unit,
transfers a block corresponding to a cache hit for data of the read access, from the cache buffer to the processor,
divides, into rectangles, blocks each corresponding to a cache miss for the data of the read access, and reads each of the rectangles as the rectangular-block group from the external memory into the cache buffer, and
prepares a new tag for the rectangular-block group read into the cache buffer, and then sets the first flag of the new tag to be valid while setting the second flag of the new tag to be invalid.

12. The semiconductor integrated circuit according to claim 10, wherein, during write access by the processor, the controller
causes the comparator to scan the tags stored in the cache tag unit,
rewrites a block corresponding to a cache hit for data of the write access, with data from the processor, while setting the second flag of one of the tags that is for the block corresponding to the cache hit, to be valid,
divides, into rectangles, blocks each corresponding to a cache miss for the data of the write access, and then stores each of the rectangles as the rectangular-block group in the cache buffer, and
prepares a new tag for the rectangular-block group stored in the cache buffer, and then sets the first flag of the new tag to be valid while setting the second flag of the new tag to be valid.
